(19) United States
(12) Patent Application Publication
(10) Pub. No.: US 2012/0068683 A1
(43) Pub. Date: Mar. 22, 2012

(54) Current Source Gate Driver with Negative Gate Voltage

(76) Inventors: Yan-Fei LIU, Kingston (CA); Zhiliang ZHANG, Nanjing (CN); Jizhen FU, El Segundo, CA (US)

(21) Appl. No.: 13/234,241

(22) Filed: Sep. 16, 2011

Related U.S. Application Data
(60) Provisional application No. 61/383,976, filed on Sep. 17, 2010.

(30) Foreign Application Priority Data
Sep. 17, 2010 (CA) 2714928

(51) Int. Cl. G05F 3/08

(52) U.S. Cl. 323/311

(57) ABSTRACT

Described herein are methods and circuits for driving a power switching device of a power converter. The methods and circuits include providing a negative gate to source voltage to the power switching device during an off transition of the power switching device, wherein the negative gate to source voltage is provided independent of one or more switching element for driving the power switching device; wherein body diode conduction by the one or more switching element is mitigated; wherein a circuit connected in parallel with the gate and source of the power switching device is used to set or define the negative gate to source voltage.

### RELATED APPLICATION

This application claims the benefit of the filing date of U.S. Provisional Patent Application No. 61/383,976, filed on 17 Sep. 2010, the contents of which are incorporated herein by reference in their entirety.

### FIELD

This invention relates to circuits and methods for a current source gate driver. More particularly, the circuits and methods herein relate to driving a power switching device of a power converter with a negative gate voltage during the off transition of the power switching device.

### BACKGROUND

Voltage regulators (VRs) in applications such as microprocessor power supplies feature low output voltage, high output current and high power density [1]. To meet the requirements of future microprocessors, it is necessary to increase the switching frequency of the VR (>1 MHz) in order to reduce the size of passive components and achieve better dynamic performance [2].

However, as the switching frequency increases, the efficiency of a buck converter using a conventional voltage source driver suffers from two frequency-dependent losses: (1) switching loss; and (2) gate drive loss [3][4]. In addition to frequency dependent loss, the impact of parasitic inductance introduced by PCB tracks and bond wires inside the MOSFET package increases at higher frequency, which introduces further switching loss [5]-[7].

One way to solve the aforementioned problems is to use a resonant gate driver (RGD) [8][9], which can recover part of the gate drive energy to the source. Some RGDs can drive two MOSFETs with a transformer or coupled inductor [10][11]. Nevertheless, the design of the transformer is challenging. Most importantly, RGDs only help reduce gate energy loss, but they cannot reduce the switching loss which is the dominant loss for high frequency operation. Therefore, the efficiency improvement potential for RGDs is limited.

Current source driver (CSD) circuits have been proposed [12]-[15] to reduce the switching loss and solve the problems of RGDs. However, previous CSD designs cannot take full advantage of the current source drive due to gate current diversion.

### SUMMARY

Described herein is a method of driving a power switching device of a power converter; comprising: providing a negative gate to source voltage to the power switching device during an off transition of the power switching device, wherein the negative gate to source voltage is provided independent of one or more switching element for driving the power switching device; wherein body diode conduction by the one or more switching element is mitigated; wherein a circuit connected in parallel with the gate and source of the power switching device is used to set or define the negative gate to source voltage.

According to an embodiment of the method, the circuit may comprise: a bi-directional switch connected between the gate and source of the power switching device; and a device in parallel with the bi-directional switch; wherein the device provides the negative gate to source voltage to the power switching device during a turn off transition of the power switching device.

In one embodiment the device may comprise a plurality of diodes connected together in series so as to have a cathode terminal and an anode terminal; wherein the plurality of diodes is connected in parallel with the bi-directional switch such that the cathode terminal is connected to the gate of the power switching device and the anode terminal is connected to the source of the power switching device. The method may include selecting a number of diodes to provide a selected negative gate to source voltage at the power switching device.

In another embodiment the device may comprise a diode and a power supply connected together in series; wherein a cathode of the diode is connected to the gate of the power switching device and an anode of the diode is connected to a negative terminal of the power supply, and a positive terminal of the power supply is connected to the source of the power switching device. The method may include adjusting the power supply to provide a selected negative gate to source voltage at the power switching device.

Also described herein is a gate driver for a power switching device of a power converter, comprising: one or more switching elements that drive the power switching device; a bi-directional switch connected between a gate and a source of the power switching device; and a device connected in parallel with the bi-directional switch; wherein the device provides a negative gate to source voltage to the power switching device during a turn off transition of the power switching device; wherein the device sets or defines the negative gate to source voltage.

In one embodiment the device may comprise a plurality of diodes connected together in series so as to have a cathode terminal and an anode terminal; wherein the cathode terminal is connected to the gate of the power switching device and an anode terminal is connected to the source of the power switching device.

In another embodiment the device may comprise a diode and a power supply connected together in series; wherein a cathode of the diode is connected to the gate of the power switching device and an anode of the diode is connected to a negative terminal of the power supply, and a positive terminal of the power supply is connected to the source of the power switching device.

The one or more switching element may be associated with a current source gate driver for the power switching device.

Also described herein is a current source gate driver for a power switching device, comprising a gate driver as described herein.

Also described herein is a current source gate driver for a power switching device, comprising: an input terminal for receiving a DC voltage; a first switch connected between the input terminal and a first node; a second switch connected between the input terminal and a second node; a third switch connected between the first node and a circuit common; an inductor connected between the first node and the second node; a bi-directional switch connected between the second node and the circuit common; and a device that provides a negative gate to source voltage at the power switching device during a turn off transition of the power switching device; wherein the device is connected in parallel with the bi-directional switch.

In one embodiment of the current source gate driver, the device may comprise a plurality of diodes connected together in series so as to have a cathode terminal and an anode terminal; wherein the cathode terminal is connected to the gate of the power switching device and an anode terminal is connected to the source of the power switching device.

In another embodiment of the current source gate driver, the device may comprise a diode and a power supply connected together in series; wherein a cathode of the diode is connected to the gate of the power switching device and an anode of the diode is connected to a negative terminal of the power supply, and a positive terminal of the power supply is connected to the source of the power switching device. The power supply may be adjustable.

Also described herein is a power converter including a gate driver as described herein.

In the embodiments described herein, the bi-directional switch may comprise two MOSFET switching devices, the switching devices connected together in series with source terminals connected together. The power switching device may be a power MOSFET. The one or more switching element may be associated with a current source gate driver for the power switching device. The power switching device may be a low side power switching device or a high side power switching device of a power converter. The power converter may be a buck converter.

### BRIEF DESCRIPTION OF THE DRAWINGS

For a more complete understanding of the invention, and to show how it may be carried into effect, embodiments are described herein with reference to the accompanying drawings, wherein:

FIG. 1 is a schematic diagram of a current source gate driver according to the prior art;

FIG. 2(a) is a schematic diagram of a current source gate driver with negative gate to source voltage according to one embodiment

FIG. 2(b) is a schematic diagram of a current source gate driver with negative gate to source voltage according to another embodiment;

FIG. 3 is a plot showing key waveforms of the circuit of FIG. 2(a);

FIGS. 4(a) to 4(h) are equivalent circuits of the circuit of FIG. 2(a) during various instances of its operation;

FIG. 5 is a schematic diagram of a buck converter including the current source driver with negative gate to source voltage of the embodiment of FIG. 2(a), as used to measure the circuit performance;

FIG. 6 shows measured driver gate signals for the circuit of FIG. 5;

FIG. 7 shows measured driver inductor current and the gate-to-source voltage of the control FET;

FIG. 8 shows measured gate to source signals for the control and synchronous rectifier MOSFETs Q₁ and Q₂ of the circuit of FIG. 5;

FIG. 9 is a plot of efficiency as a function of load current at 1.2V and 1.3V, for the circuit of FIG. 5;

FIG. 10 is a plot of efficiency as a function of load current at 1.2V for a buck converter with a CSD with negative gate to source voltage as described herein (squares), a CSD according to FIG. 1, and a conventional voltage source driver;

FIG. 11 is plot of efficiency as a function of load current at 1.3V for a buck converter with a CSD with negative gate to source voltage as described herein (squares), a CSD according to FIG. 1, and a conventional voltage source driver;

FIG. 12 is a schematic diagram of a dual channel bipolar current source gate driver with continuous inductor current, according to an alternative embodiment; and

FIG. 13 is a schematic diagram of a bipolar CSD working with continuous inductor current mode according to an alternative embodiment.

### DETAILED DESCRIPTION OF EMBODIMENTS

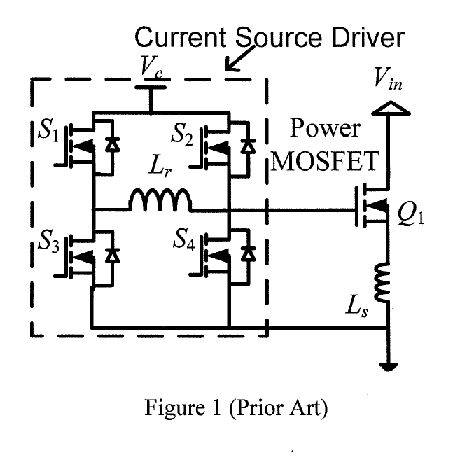

A current source gate driver as proposed in [15] is shown in FIG. 1. The circuit includes switches S₁-S₄, shown with their body diodes, driver inductor Lᵣ, MOSFET Q₁, and the source inductance Lₛ. This circuit features minimal circulating current and thus minimal conduction loss; suitability for narrow duty cycle operation; small inductor value, for easier implementation as integrated circuit; and soft switching of driver MOSFETs. However, a potential problem of the current source gate driver of FIG. 1 is gate current diversion during the switching transition, due to conduction of the body diode of the gate drive switch S₄.

As used herein, the term “source inductance”, or “Lₛ”, includes inductance external to the MOSFET package, such as inductance of the printed circuit board (PCB) track and/or other external wiring, and inductance internal to the MOSFET package, such as inductance of the source bond wire.

As used herein, the term “current source driver”, or “CSD” are intended to refer to a current source gate driver, and the terms may be used interchangeably.

The circuits and methods described herein are based, at least in part, on the realization that the problem of gate current diversion during the power MOSFET switching transition is due to a slow turn off transition of the power MOSFET, and/or the power MOSFET not being fully switched off. It has now been found by the inventors that this problem can be substantially alleviated by accelerating the turn off characteristic of the power MOSFET, by providing it with a more negative gate to source voltage during the turn off transition. As used herein, the terms “more negative gate to source voltage” and “more strongly negative gate to source voltage” refer to a gate to source voltage that is of a greater negative magnitude than that provided by a conventional current source gate driver. For example, a voltage of −3 V is a more negative voltage than −1 V. The more negative gate to source voltage improves the turn off transition of the power MOSFET by reducing the turn off transition time, and ensuring that the power MOSFET is substantially fully turned off during the reduced transition time.

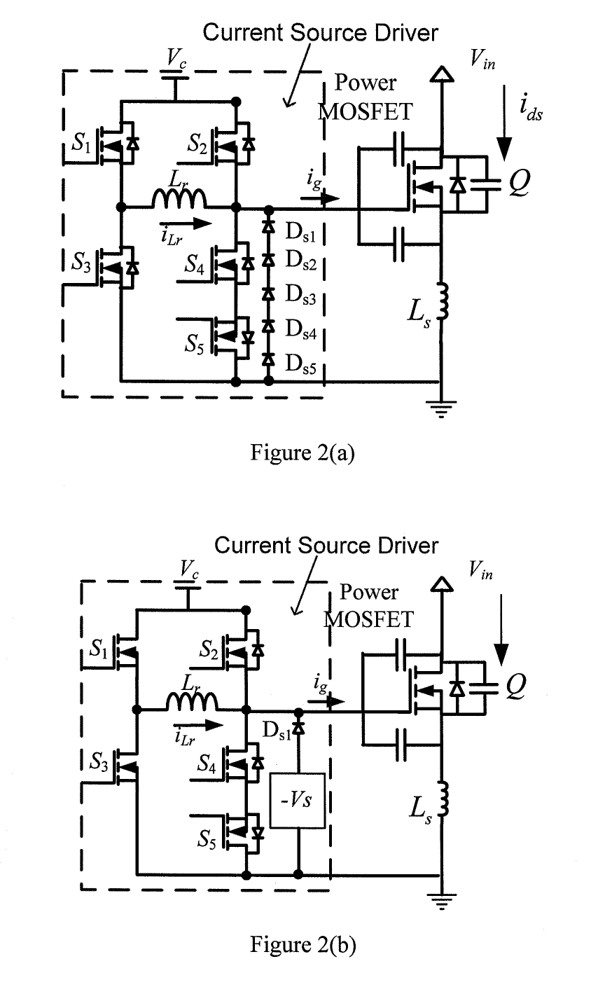

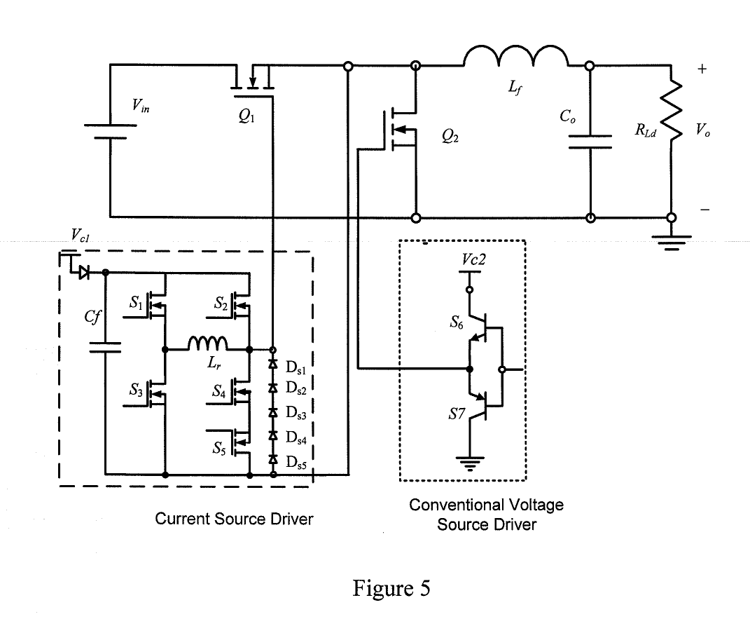

Described herein is a current source gate driver with a more strongly negative gate to source voltage during turn off of the power MOSFET (for simplicity, the driver will be referred to herein as a “current source gate driver with negative gate voltage”). Embodiments for driving the low side of a power converter such as a buck converter are shown in FIGS. 2(a) and (b). However, it will be appreciated that a current source gate driver with negative gate voltage as described herein may be configured for driving the high side power MOSFET of a power converter. For example, the circuits of FIGS. 2(a) and (b) may be configured as high side drivers, wherein the ground connection shown in the figures would instead be the common node between the power switching devices of a power converter such as a buck converter. Such an embodiment is shown in FIG. 5, discussed below.

A current source gate driver with negative gate voltage as described herein substantially alleviates or reduces the gate current diversion problem mentioned above, and reduces the switching loss. In the embodiments of FIGS. 2(a) and 2(b), components common to the circuit of FIG. 1 have the same label. Switches S₁-S₅ are shown with their body diodes, referred to herein as D₁-D₅, respectively. The power MOSFET Q is shown with its body diode, source inductance Lₛ, and intrinsic drain to source, gate to drain, and gate to source capacitances. It is expected that in most applications, the power switching device will be a power MOSFET. Accordingly, embodiments are described herein primarily with regard to power MOSFETs. However, it will be appreciated that other types of power switching devices can be used, such as, for example, a MESFET, JFET, or insulated gate bipolar transistor (IGBT). In the case of an IGBT, the collector and emitter terminals replace the drain and source terminals of a MOSFET.

Compared with the current source gate driver in FIG. 1, in the current source gate driver with negative gate voltage embodiments of FIGS. 2(a) and 2(b) S₄ is replaced by S₄ and S₅, which are connected in series with source terminals connected together as one bi-directional switch, such that the drain terminals are the switch terminals. The bi-directional switch may also be referred to as a “four quadrant switch”. In a bi-directional switch, current can flow in both directions when in the on state, and current cannot flow in either direction when in the off state, independent of the voltage across the switch terminals, which can be a positive or a negative voltage. Accordingly, this arrangement may be used to block conduction of the body diodes of S₄ and S₅.

As also shown in FIG. 2(a), a current source gate driver with negative gate voltage as described herein may include a series circuit of diodes, wherein the series circuit of diodes is connected in parallel with the series circuit of S₄ and S₅, such that the cathode end of the series circuit of diodes is connected to the gate of the power MOSFET Q and the anode end of the series circuit of diodes is connected to the source of the power MOSFET Q. For example, five diodes Dₛ₁-Dₛ₅ may be connected together in series, as shown in FIG. 2(a). The diodes provide an alternative path to the S₄ and S₅ branch to create a more negative gate to source voltage during the turn-off transition of the power MOSFET Q, which can noticeably increase the effective discharge current.

The number of diodes may vary depending on the power switching device used, and the desired negative gate to source voltage for the power switching device. For example, the number of diodes may be chosen to provide a gate to source voltage that is more negative than the voltage resulting from the body diodes of S₄ alone (e.g., more negative than −0.7 V). It will be appreciated that a zener diode may be used in place of the series circuit of diodes; however, a zener diode may impose a limitation for high frequency operation of the power converter. Another embodiment for the series circuit of diodes includes a voltage regulator or a series circuit including a diode and a capacitor. In a further embodiment, shown in FIG. 2(b), a programmable configuration includes an external negative power supply and a single diode in place of diodes Dₛ₁-Dₛ₅. Such a configuration provides a negative gate to source voltage (i.e., −V_{gs}), where the resulting negative gate to source voltage is −V_{gs}−0.7 V. Further, such a configuration permits tuning of a negative gate to source voltage for the power switching device. These alternative embodiments may be implemented either within the driver device, or external to the driver.

In prior current source gate drivers, such as that shown in FIG. 1, it is via body diode conduction in S₄ that the power MOSFET gate voltage is limited during the turn off transition, resulting in gate current diversion. Embodiments described herein provide an alternate path for that current so as to maintain a greater negative gate to source voltage at the power MOSFET. For example, this is provided by the combination of the bi-directional switch and the series circuit of diodes (FIG. 2(a)), which provide as much negative voltage as possible to turn off the power MOSFET, for the same current.

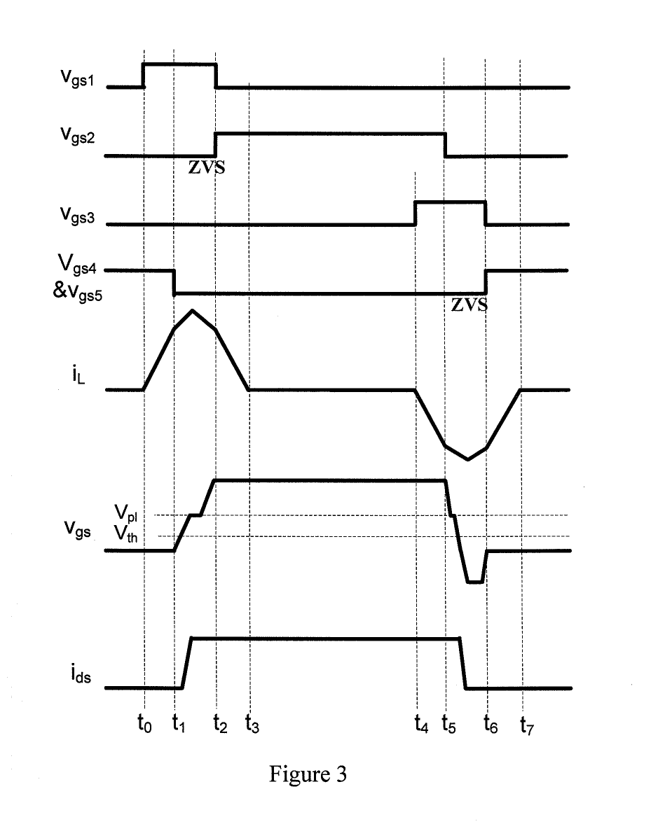

The waveforms of the five switch driving signals, v_{gs1}-v_{gs5}, along with the inductor current i_{Lr}, power MOSFET gate-to-source voltage v_{gs}, and the drain-to-source current i_{ds}, are illustrated in FIG. 3. In one embodiment the gate signals of S₄ and S₅ may be the same through the switching cycles. The switches S₁-S₅ and diodes Dₛ₁-Dₛ₅ are controlled so as to charge and discharge the power MOSFET with a nearly constant current during intervals (t₁, t₂) and (t₅, t₆).

### Turn On Operation

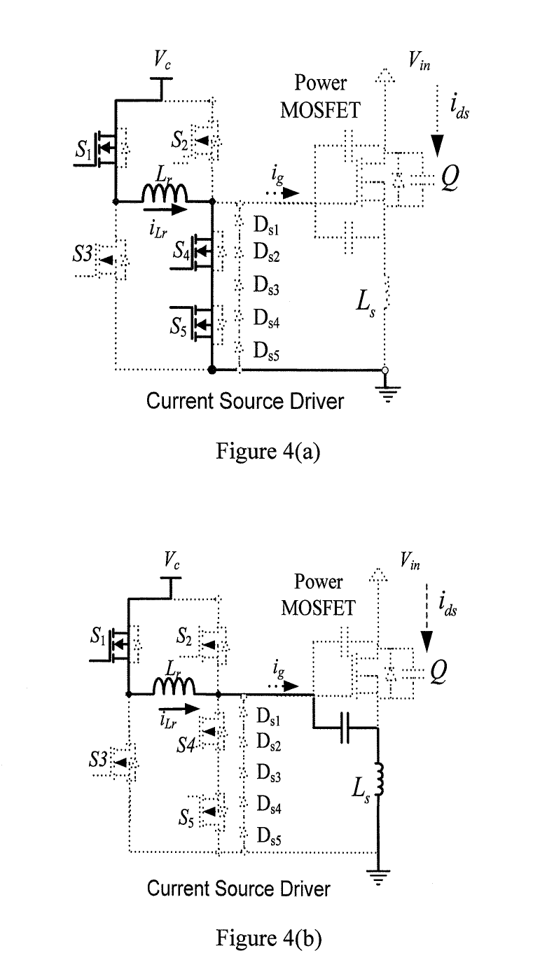

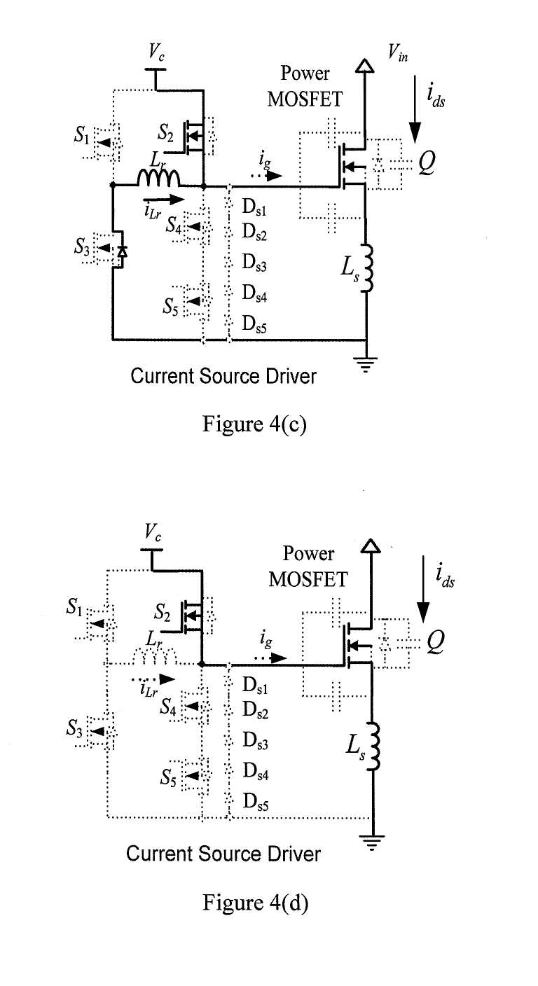

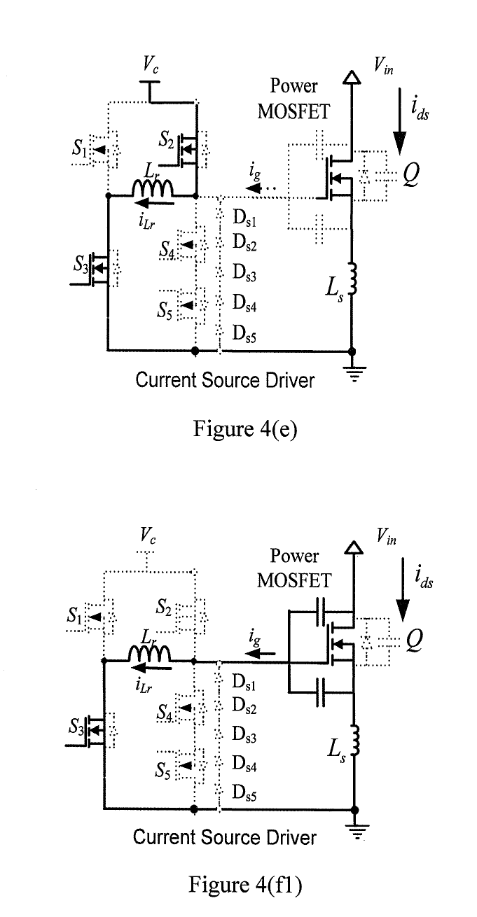

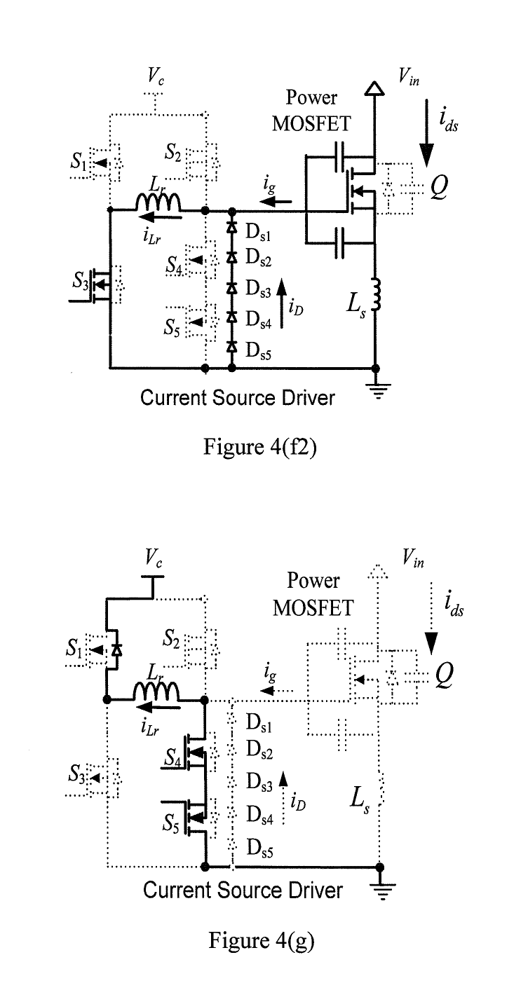

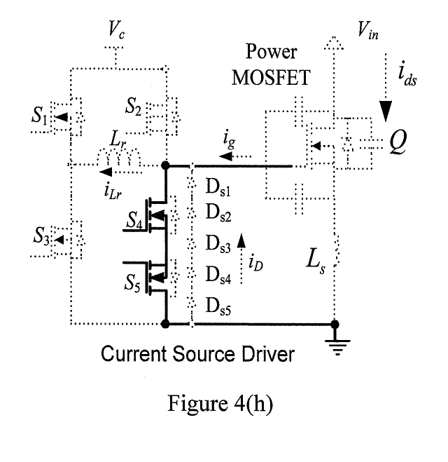

Operation of the embodiment shown in FIG. 2(a) during a turn on transition will now be described in detail with reference to FIGS. 3 and 4(a) to 4(d). Prior to t₀, the power MOSFET is assumed to be in the OFF state.

1. Turn on pre-charge (t₀, t₁): At t₀, S₁ is turned on, and the inductor current i_{Lr} rises almost linearly in the positive direction through the current path shown in FIG. 4(a). The pre-charge state ends at t₁, which may be set according to the circuit design.

2. Turn on switching interval (t₁, t₂): After S₄ and S₅ are turned off at t₁, the inductor current i_{Lr} begins to charge the power MOSFET through the current path given in FIG. 4(b). The interval ends at t₂ when v_{gs} is equal to V_{c}. The inductor current increases due to the resonance of the inductor Lᵣ and the input capacitance of the power MOSFET C_{gs}. During this interval, the gate current remains at a high level, therefore the power MOSFET is charged with a substantially constant current. The interval ends at t₂ when the switching transition ends.

3. Energy recovery (t₂, t₃): At t₂, S₁ is turned off and S₂ is turned on (with ZVS). The body diode of the switch S₃, D₃, is driven on, and the circuit goes into the energy recovery interval. The inductor current decreases sharply to zero through the path shown in FIG. 4(c). The interval ends at t₃ when the inductor current becomes zero. The gate voltage of the power MOSFET is clamped to V_{c} through a low impedance path, which prevents the circuit being false triggered by Cdv/dt effect.

After t₃, the inductor current remains zero and D₃ is turned off. The power MOSFET remains in the on state as shown in FIG. 4(d).

### Turn OFF Operation

Operation of the embodiment shown in FIG. 2(a) during a turn off transition will now be described in detail with reference to FIGS. 3 and 4(e) to 4(h). Prior to t₄, the power MOSFET is assumed to be in the ON state.

1. Turn off pre-charge (t₄, t₅): At t₄, S₃ is turned on, and the inductor current i_{Lr} rises almost linearly in the negative direction through the current path shown in FIG. 4(e). The pre-charge state ends at t₅, which may be set according to the circuit design, and S₂ is turned off with ZVS at t₅.

2. Turn off switching transition (t₅, t₆): After S₂ is turned off at t₅, the inductor current i_{Lr} begins to discharge the power MOSFET through the current path given in FIG. 4(f₁). The gate-to-source capacitance of the power MOSFET V_{Cgs} and the drain current i_{ds} both decrease in this interval. Due to the effect of Lₛ, Dₛ₁-Dₛ₅ are driven on, clamping V_{gs} at about −3.5V. The equivalent circuit of this interval is shown in FIG. 4(f2). Compared with the prior current source gate driver in FIG. 1, a more negative voltage will be applied to the source inductor Ls. This can be determined from Equation (1), below. For the embodiment shown in FIG. 2, V_{gs} is about −3.5V, while for the prior circuit shown in FIG. 1, V_{gs} is about −0.7V. Therefore, the current falling rate of the source inductor, which is the same as the power MOSFET falling current rate, will be increased, and therefore, it takes less time for the power MOSFET current to fall to zero, which is equivalent to less switching time.

According to Equation (1):

$${V}_{gs} = - {i}_{g} {R}_{g} + {V}_{Cgs} - {L}_{s} \frac{d {i}_{ds}}{d t} \qquad ( 1 )$$

where V_{Cgs} represents the voltage across the gate-to-source capacitance of the power MOSFET Q, i_{g} is the effective discharge current, R_{g} represents the gate resistance, Lₛ is the source inductance (as defined above), and i_{ds} represents the drain-to-source current.

The power MOSFET can be considered to be discharged with a constant effective discharge current defined by Equation (2)

i_{g}=i_{Lr}−i_{D4} (2)

where i_{g} is the effective discharge current, i_{Lr} is the current flowing in the inductor, and i_{D4} is the current diverted in the body diode D₄.

The interval ends at t₆ when the voltage across the gate-to-source capacitance is lower than Vₜₕ at t₆.

3. Energy recovery (t₆, t₇): At t₆, S₃ is turned off and S₄ and S₅ are turned on with ZVS. The body diode of S₁, D₁, is forced on by i_{Lr}, and the circuit goes into energy recovery mode through the path shown in FIG. 4(g). During this interval, the energy stored in Lᵣ is recovered to V_{c}. The interval ends at t₇ when the inductor current becomes zero.

After t₇, the source inductor current remains zero and the body diode of the power MOSFET is turned off. The power MOSFET is in the off state in FIG. 4(h).

A current source gate driver with negative gate voltage as described herein exhibits significantly reduced switching time and turn-off loss. During the turn off transition, the gate discharge current is not diverted to diodes Dₛ₁-Dₛ₅ until the gate to source voltage reaches a much more negative voltage (e.g., <−3V). In the CSD of FIG. 1, V_{gs}=−0.7V because of the conduction of D₄, and V_{Cgs} is obtained by Equation (3) using a piecewise linear approximation [17]. According to the datasheet for the power MOSFET Si7386DP used, Vₚₗ=3.5V, Vₜₕ=2V, R_{g}=1.7Ω. Assuming i_{g}=1 A, then Lₛdi_{ds}/dt=1.75V according to Equation (1). However, for a current source gate driver with negative gate voltage, V_{gs}=−3.5V, then Lₛdi_{ds}/dt=4.55V. Therefore, the turn-off time of a current source gate driver with negative gate voltage is about one third of that for the prior CSD of FIG. 1, which means faster turn-off transition.

In Equation (3),

$${V}_{Cgs} = \frac{{V}_{pl} + {V}_{th}}{2} \qquad ( 3 )$$

where V_{Cgs} is the voltage across the gate-to-source capacitance of the power MOSFET Q, Vₚₗ means the Miller plateau voltage of Q, and Vₜₕ is the gate threshold voltage of Q.

A current source gate driver with negative gate voltage as described herein reduces the impact of parasitic inductance. Whether in a conventional driver or a CSD as shown in FIG. 1, parasitic inductance significantly reduces the switching speed and thereby reduces efficiency [16]. A current source gate driver with negative gate voltage as described herein reduces the impact of the parasitic inductor with V_{gs} clamped to a negative voltage, which reduces the turn-off time and thereby improves efficiency.

A current source gate driver with negative gate voltage as described herein uses a smaller current source inductor than conventional CSDs or the CSD of FIG. 1. The current source gate driver with negative gate voltage operates in discontinuous mode, which allows the current source inductor to be small. This may be advantageous in circuit implementations where size is a constraint.

A current source gate driver with negative gate voltage as described herein has high stability and noise immunity. The power MOSFET is either actively clamped to Vcc during on, or to zero during off, which minimizes the possibility for the power MOSFET to be falsely triggered (e.g., by the Cdv/dt effect) and increases stability of the circuit.

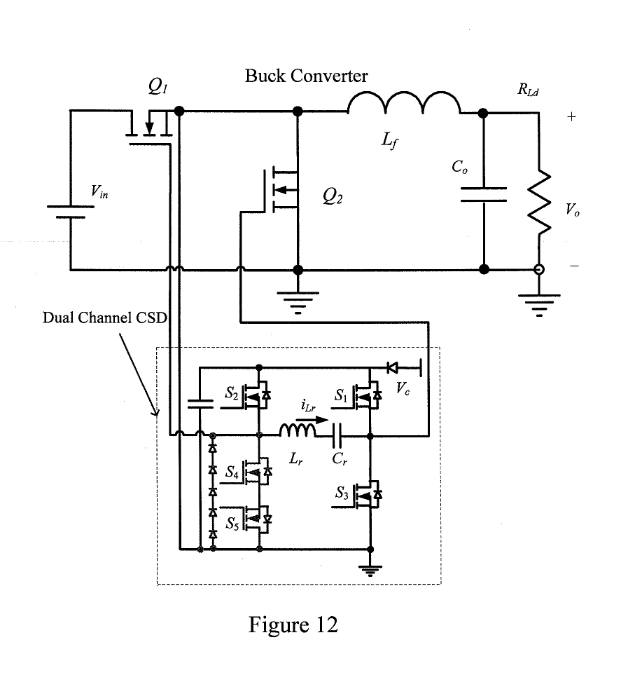

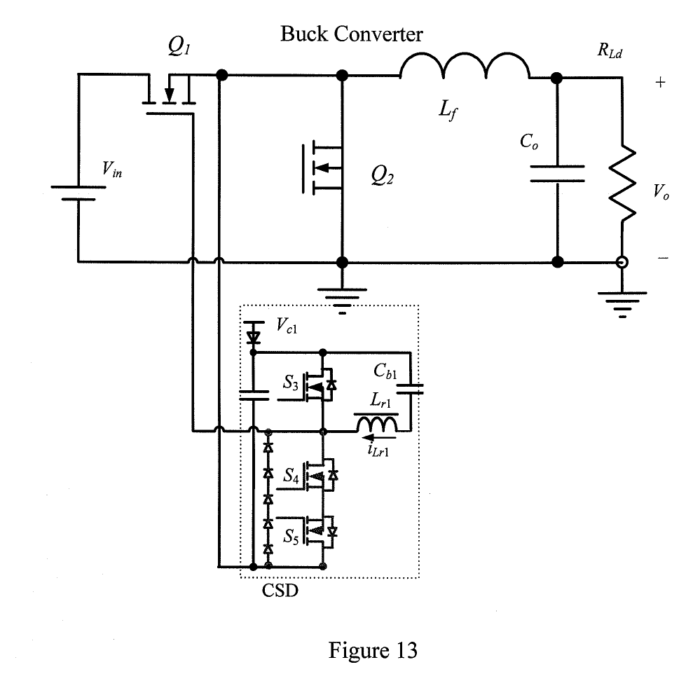

Embodiments have been described herein primarily as applied to a current source gate driver. However, other embodiments may include other gate drivers, such as, for example, a dual channel bipolar current source gate driver (see FIG. 12), wherein both the high side and low side power MOSFETs of a buck converter may be driven, and a bipolar current source gate driver working in continuous inductor current mode (see FIG. 13) to enhance performance.

Embodiments have been described herein primarily as applied to a buck converter. However, other embodiments may include other power converters, such as, for example, half bridge, full bridge, boost, and flyback power converters.

Embodiments are further described by way of the following non-limiting example.

### EXAMPLE

A synchronous buck converter including a CSD with negative gate voltage was built as shown in FIG. 5. For simplicity, the control FET of the buck converter was driven by a CSD with negative gate voltage, while the SR was driven by a conventional voltage source driver. The design parameters are given in Table 1.

TABLE 1
Design Parameters

| | |
|---|---|
| Switching Frequency, fₛ | 1 MHz |
| Input Voltage, Vᵢₙ | 12 V |
| Output Voltage, Vₒ | 1.2-1.3 V |
| SR Gate Drive Voltage, V_{c2} | 6.5 V |
| SR, Q₂ | IRF6691 |
| CSD Voltage, V_{c1} | 5 V |
| Control FET, Q₁ | Si7386DP |
| Output Inductor, L_{f} (330nH) | Vishay IHLP5050CE |
| Driver Switches, S₁-S₅ | FDN335N |
| Driver Inductor, Lᵣ (43nH) | Coilcraft B10T_L |
| Diodes, Dₛ₁-Dₛ₅ | MBR0520 |

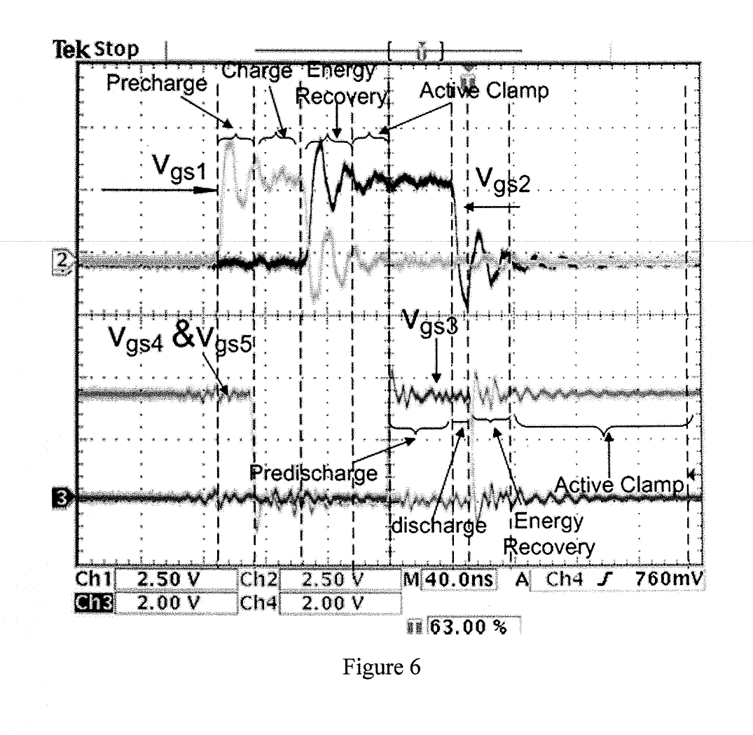

FIG. 6 shows switch gate signals v_{gs1}-v_{gs5} and four corresponding modes for the turn-on and turn-off transitions.

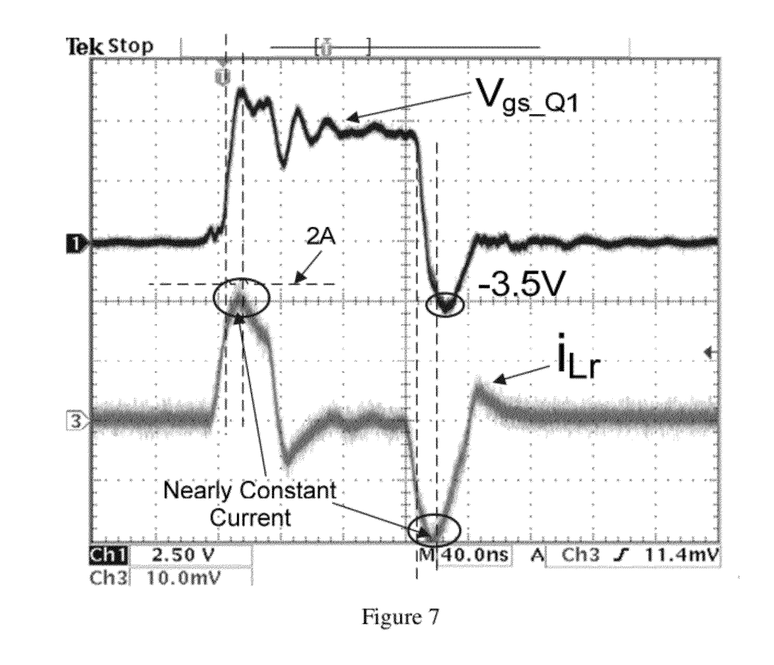

FIG. 7 shows the driver inductor current i_{Lr} and the gate-to-source voltage V_{gs}_{_{—}}_{Q1} of control FET. It can be seen that V_{gs}_{_{—}}_{Q1} is clamped to about −3.5V, and Q1 is charged and discharged with nearly constant current. Most importantly, there is no Miller Plateau observed in V_{gs}_{_{—}}_{Q1}. The waveform of the effective charge current, i_{g}, is not provided due to the difficultly in measuring it without disturbing the circuit operation.

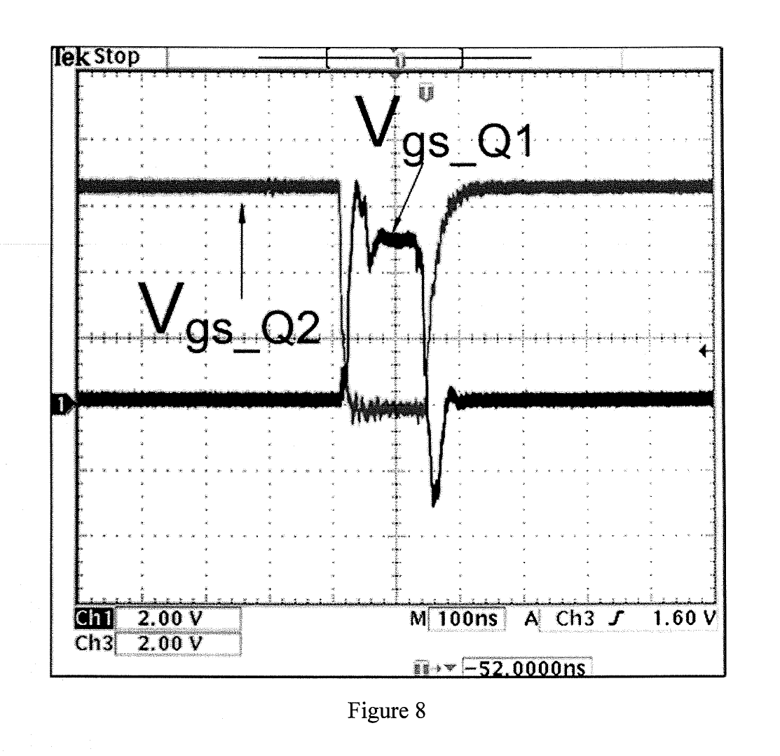

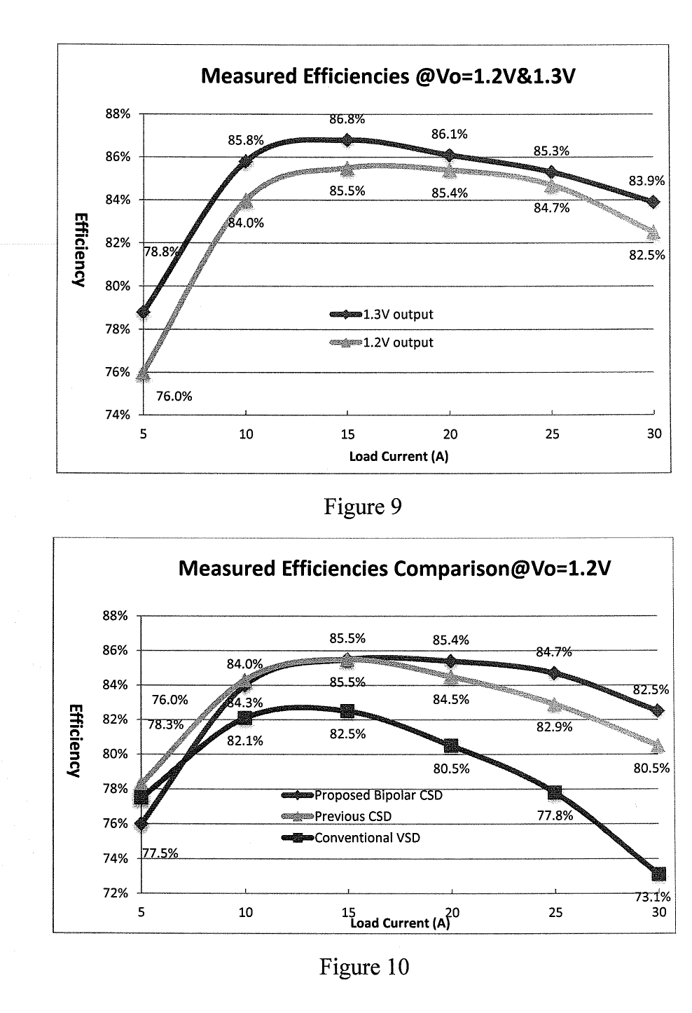

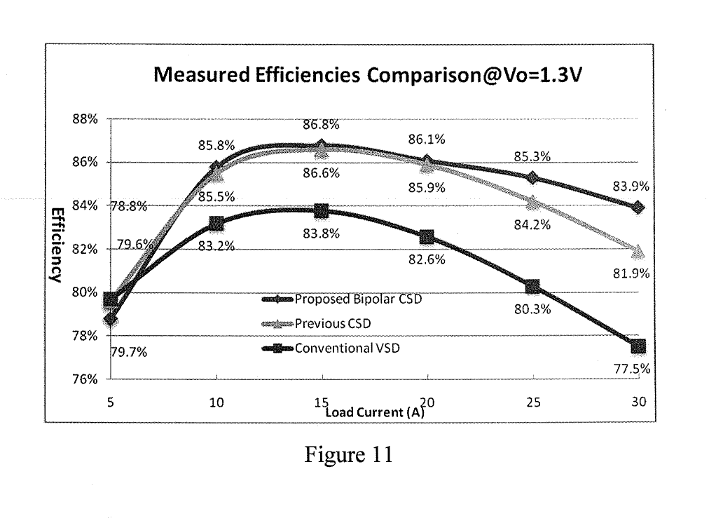

It can be observed in FIG. 8 that the dead time between V_{gs}_{_{—}}_{Q1} and V_{gs}_{_{—}}_{Q2} is adjusted to be minimal, with a view to avoiding shoot-through and minimizing the switching loss.

FIG. 13 summarizes the efficiency of the circuit at 1.2V and 1.3V outputs. FIGS. 14 and 15 compare efficiency of the CSD with negative gate voltage, the CSD of FIG. 1, and a conventional voltage source driver at 1.2V output and 1.3V output, respectively. It can be seen that, compared to the conventional voltage source driver, the CSD with negative gate voltage increases the efficiency from 73.1% to 82.5% (i.e., by 9.4%) at 1.2V/30 A output (a loss reduction of 5.62 W) and from 77.5% to 83.9% (i.e., by 6.4%) at 1.3V/30 A output (a loss reduction of 3.84 W). Compared with the CSD of FIG. 1, the CSD with negative gate voltage improves the efficiency from 80.5% to 82.5% at 1.2V/30 A output (a loss reduction of 1.2 W) and 81.9% to 83.9% at 1.2V/30 A output (a loss reduction of 1.24 W). It is also observed that the CSD with negative gate voltage achieves a better efficiency improvement at high load current. This is because the circuit significantly alleviates the gate current diversion problem at high current load.

All cited publications are incorporated herein by reference in their entirety.

### Equivalents

Those skilled in the art will recognize or be able to ascertain equivalents to the embodiments described herein. Such equivalents are considered to be encompassed by the invention and are covered by the appended claims.

### REFERENCES

[1] Ed Standford “Power Technology Road Map for Microprocessor Voltage Regulators” APEC2004 Presentation.

[2] Y. Han, O. Leitermann, D. A. Jackson, J. M. Rivas and D. J. Perreault, “Resistance compression networks for radio-frequency power conversion,” IEEE Trans. Power Electron., Vol. 22, No. 1, March 2007, pp. 41-53.

[3] R. W. Erickson and D. Maksimovic, “Fundamentals of Power Electronics”, 2nd. Edition, Kluwer Academic Publishers, 2001.

[4] T. Lopez, G. Sauerlaender, T. Duerbaum and T. Tolle, “A detailed analysis of a resonant gate driver for PWM applications,” in Proc. IEEE APEC, 2003, pp. 873-878.

[5] D. A. Grant and J. Gowar, “Power MOSFET Theory and Applications”. New York: Wiley, 1989

[6] Y. Ren, M. Xu, J. Zhou, and F. C. Lee, “Analytical Loss Model of Power MOSFET,” IEEE Trans. Power Electronics, Vol. 21, No. 2, March 2006, pp. 310-319.

[7] Y. Xiao, H. Shah, R. Natarajan, E. J. Gutmann, “Analytical Modeling and experimental evaluation of interconnect parasitic inductance on MOSFET switching characteristics,” in Proc. IEEE APEC, 2004, Vol. 1, pp 516-521.

[8] D. Maksimovic, “A MOS gate drive with resonant transitions,” in Proc. IEEE PESC, 1991, pp. 527-532.

[9] Y. Chen, F. C. Lee, L. Amoros and H. Wu, “A resonant MOSFET gate driver with efficient energy recovery,” IEEE Trans. Power Electron., Vol. 19, No. 2, pp. 470-477, March 2004.

[10] K. Yao and F. C. Lee, “A novel resonant gate driver for high frequency synchronous buck converters,” IEEE Trans. Power Electron., Vol. 17, No. 2, pp. 180-186, March 2002.

[11] Y. Ren, M. Xu, Y. Meng and F. C. Lee, “12V VR efficiency improvement based on two-stage approach and a novel gate driver,” in Proc. IEEE PESC, 2005, pp. 2635-2641.

[12] Z. Yang, S. Ye and Y. F. Liu, “A new dual channel resonant gate drive circuit for synchronous rectifiers,” in Proc. IEEE Applied Power Electronics Conf., 2006, pp. 756-762.

[13] Z. Zhang, W. Eberle, Z. Yang, Y. F. Liu and P. C. Sen, “Optimal design of current source gate driver for a buck voltage regulator based on a new analytical loss model,” in Proc. IEEE PESC, 2007, pp. 1556-1562.

[14] Z. Yang, S. Ye and Y. F. Liu, “A new resonant gate drive circuit for synchronous buck converter,” IEEE Trans. Power Electronics, Vol. 22, No. 4, July 2007, pp. 1311-1320.

[15] W. Eberle, Z. Zhang, Y. Liu and P. C. Sen, “A high efficiency synchronous buck VRM with current source gate driver,” in Proc. IEEE PESC, 2007, pp. 21-27.

[16] Z. Zhang, W. Eberle, P. Liu, Y. F. Liu, P. C. Sen, “A 1-MHz high-efficiency 12-V buck voltage regulator with a new current-source gate driver”, IEEE Transactions on Power Electronics, Vol. 23, No. 6, November 2008, pp. 2817-2827.

[17] W. Eberle, Z. Zhang, Y. F. Liu, P. C. Sen, “A Practical switching loss model for buck voltage regulators”, IEEE Transactions on Power Electronics, Vol. 24, No. 3, March 2009, pp. 700-7.

1. A method of driving a power switching device of a power converter; comprising:
providing a negative gate to source voltage to the power switching device during an off transition of the power switching device, wherein the negative gate to source voltage is provided independent of one or more switching element for driving the power switching device;
wherein body diode conduction by the one or more switching element is mitigated;
wherein a circuit connected in parallel with the gate and source of the power switching device is used to set or define the negative gate to source voltage.

2. The method of claim 1, wherein the circuit comprises:
a bi-directional switch connected between the gate and source of the power switching device; and
a device in parallel with the bi-directional switch;
wherein the device provides the negative gate to source voltage to the power switching device during a turn off transition of the power switching device.

3. The method of claim 2, wherein the device comprises a plurality of diodes connected together in series so as to have a cathode terminal and an anode terminal;
wherein the plurality of diodes is connected in parallel with the bi-directional switch such that the cathode terminal is connected to the gate of the power switching device and the anode terminal is connected to the source of the power switching device.

4. The method of claim 2, wherein the device comprises a diode and a power supply connected together in series;
wherein a cathode of the diode is connected to the gate of the power switching device and an anode of the diode is connected to a negative terminal of the power supply, and a positive terminal of the power supply is connected to the source of the power switching device.

5. The method of claim 3, including selecting a number of diodes to provide a selected negative gate to source voltage at the power switching device.

6. The method of claim 4, including adjusting the power supply to provide a selected negative gate to source voltage at the power switching device.

7. The method of claim 2, wherein the bi-directional switch comprises two MOSFET switching devices, the switching devices connected together in series with source terminals connected together.

8. The method of claim 1, wherein the power switching device is a power MOSFET.

9. The method of claim 1, wherein the one or more switching element is associated with a current source gate driver for the power switching device.

10. The method of claim 1, wherein the power switching device is a low side power switching device of a power converter.

11. The method of claim 1, wherein the power switching device is a high side power switching device of a power converter.

12. The method of claim 1, wherein the power converter is a buck converter.

13. A gate driver for a power switching device of a power converter, comprising:
one or more switching elements that drive the power switching device;
a bi-directional switch connected between a gate and a source of the power switching device; and
a device connected in parallel with the bi-directional switch;
wherein the device provides a negative gate to source voltage to the power switching device during a turn off transition of the power switching device;
wherein the device sets or defines the negative gate to source voltage.

14. The gate driver of claim 13, wherein the device comprises a plurality of diodes connected together in series so as to have a cathode terminal and an anode terminal;
wherein the cathode terminal is connected to the gate of the power switching device and an anode terminal is connected to the source of the power switching device.

15. The gate driver of claim 13, wherein the device comprises a diode and a power supply connected together in series;
wherein a cathode of the diode is connected to the gate of the power switching device and an anode of the diode is connected to a negative terminal of the power supply, and a positive terminal of the power supply is connected to the source of the power switching device.

16. The gate driver of claim 9, wherein the power supply is adjustable so as to provide a selected negative gate to source voltage at the power switching device.

17. The gate driver of claim 13, wherein the bi-directional switch comprises two MOSFET switching devices, the switching devices connected together in series with source terminals connected together.

18. The gate driver of claim 13, wherein the power switching device is a power MOSFET.

19. The gate driver of claim 13, wherein the one or more switching element is associated with a current source gate driver for the power switching device.

20. The gate driver of claim 13, wherein the power switching device is a low side power switching device of a power converter.

21. The gate driver of claim 13, wherein the power switching device is a high side power switching device of a power converter.

22. The gate driver of claim 13, wherein the power converter is a buck converter.

23. A current source gate driver for a power switching device, comprising the gate driver of claim 13.

24. A current source gate driver for a power switching device, comprising:
an input terminal for receiving a DC voltage;
a first switch connected between the input terminal and a first node;
a second switch connected between the input terminal and a second node;
a third switch connected between the first node and a circuit common;
an inductor connected between the first node and the second node;
a bi-directional switch connected between the second node and the circuit common; and
a device that provides a negative gate to source voltage at the power switching device during a turn off transition of the power switching device;
wherein the device is connected in parallel with the bi-directional switch.

25. The current source gate driver of claim 24, wherein the device comprises a plurality of diodes connected together in series so as to have a cathode terminal and an anode terminal;
wherein the cathode terminal is connected to the gate of the power switching device and an anode terminal is connected to the source of the power switching device.

26. The current source gate driver of claim 24, wherein the device comprises a diode and a power supply connected together in series;
wherein a cathode of the diode is connected to the gate of the power switching device and an anode of the diode is connected to a negative terminal of the power supply, and a positive terminal of the power supply is connected to the source of the power switching device.

27. The current source gate driver of claim 26, wherein the power supply is adjustable.

28. A power converter including the gate driver of claim 13.
